(19) United States
(12) Patent Application Publication
(10) Pub. No.: US 2024/0159104 A1
(43) Pub. Date: May 16, 2024

(54) ELECTROMECHANICAL ACTUATOR AND CLOSURE, COVERING OR SOLAR PROTECTION INSTALLATION COMPRISING SUCH AN ELECTROMECHANICAL ACTUATOR

(71) Applicant: SOMFY ACTIVITES SA, CLUSES (FR)

(72) Inventor: Héléna ROBERT, CLUSES (FR)

(21) Appl. No.: 18/552,375

(22) PCT Filed: Dec. 1, 2021
(86) PCT No.: PCT/EP2021/083841

§ 371 Date: Sep. 25, 2023

(30) Foreign Application Priority Data
Mar. 31, 2021 (FR) 21 03353

(51) Int. Cl. E06B 9/72; E06B 9/174

(52) U.S. Cl. CPC E06B 9/72; E06B 9/174

(57) ABSTRACT

The invention relates to an electromechanical actuator for driving a winding tube of a closure, occultation or solar protection installation, which comprises at least a housing, a torque support arranged at a first end of the housing, an electric supply cable, an electric motor, and an electronic control unit comprising at least one electronic board arranged inside the torque support. The torque support forms a recess into which the electronic board is at least partially inserted. The electromechanical actuator further comprises an electrically insulating cover, forming a space for receiving at least part of the electronic board, the insulating cover closing the recess in the torque support, the recess and the insulating cover together forming a protective case for the electronic board.

The present invention relates to an electromechanical actuator for a closing, occultation or solar protection installation, i.e. an electromechanical actuator of a closure, occultation or solar protection installation, as well as a closure, occultation, or solar protection installation comprising a motorized driving device comprising such an actuator.

In general, the present invention relates to the field of occultation devices comprising a motorized drive device moving a screen between at least one first position and at least one second position.

A motorized driving device generally comprises an electromechanical actuator of a movable closure, occultation, or solar protection element, such as a shutter, door, gate, blind, or any other equivalent equipment, hereinafter referred to as a screen.

Electromechanical actuators for closure, occultation or solar protection installations are already known, comprising a housing, a torque support, an electric supply cable, an electric motor and a device for discharging electrostatic charge. The torque support is arranged at an end of the housing. The electric supply cable is configured to be connected to an electrical power supply network. The electric motor is mounted inside the housing and is supplied with electrical energy by means of the supply cable. The torque support comprises a selection device, a display device and a recess. The recess accommodates at least one selection device or display device.

In such installations, electrostatic charges are generated by the friction of the screen, in particular a canvas, against a plastic or metal part, in particular a winding tube of the screen or a support holding the winding tube.

Known electromechanical actuators are said of “electrical protection class 1”, i.e. they are electrically insulated by means of an earth connection to which the metal parts are electrically connected.

Such electromechanical actuators are thus electrically connected to an earth, by means of an electrical earth conductor connected electrically to the housing of the electromechanical actuator made of a metallic material, allowing electrostatic charges to be discharged.

However, these electromechanical actuators, known as “electrical protection class 1” actuators, have the disadvantage of using only a simple electrical insulation, leading to an increase in the costs of obtaining them, due to the electrical connection between the actuator housing and an electrical earth conductor.

In addition, the housing of the electromechanical actuator is made of a material that is necessarily electrically conductive, to discharge electrostatic charges.

In addition, where “electrical protection class 2” electromechanical actuators can be used in closure, occultation or solar protection installations, they are not electrically earthed; in other words, they have reinforced electrical insulation with no accessible metal parts.

However, these actuators, known as “electrical protection class 2” actuators, have the disadvantage of discharging electrostatic charges through a printed circuit board of an electronic control unit of the electromechanical actuator, and then through the electrical power supply network. Such an electronic control unit is usually mounted on the torque support.

Consequently, the discharge of electrostatic charges through the printed circuit board can cause these electromechanical actuators to malfunction and/or be damaged, in particular by destroying electronic components.

The electrical protection classes for electromechanical actuators are defined in standards IEC 60-335-1 and 2.

The purpose of the present invention is to resolve the aforementioned disadvantages and to propose an electromechanical actuator, as well as a closure, occultation or solar protection installation comprising such an electromechanical actuator, making it possible to protect the electronic components of an electronic control unit of the actuator from the discharge of electrostatic charges generated by the friction of the screen, so as to guarantee the operating reliability of this electromechanical actuator.

In this respect, the present invention is directed, according to a first aspect, to an electromechanical actuator for driving a winding tube of a closure, occultation or solar protection installation, the electromechanical actuator comprising at least:
a housing,
a torque support, the torque support being arranged at a first end of the housing,
an electric supply cable, the supply cable being configured to be connected to an electrical energy supply network,
an electric motor, the electric motor being mounted within the housing, the electric motor being supplied with electrical power via the electrical power supply cable, and
an electronic control unit comprising at least one electronic board, the electronic board being arranged inside the torque support.

According to the invention, the torque support forms a recess in which the electronic board is at least partially inserted, and the electromechanical actuator also comprises an electrically insulating cover, forming a space for receiving at least part of the electronic board, the insulating cover closing the recess of the torque support, the recess and the insulating cover together forming a protective case for the electronic board.

Thanks to the invention, the electronic board is housed in the insulating cover, which thus protects the electronic board from electrostatic discharges by lengthening the path of an electrostatic discharge. A discharge of an electrostatic charge is guided by the cover around the electronic board, which prevents damage to electronic components mounted on the electronic board.

According to advantageous but not mandatory aspects of the invention, the electromechanical actuator incorporates one or more of the following features, used in isolation or in any combination that is technically feasible:
The insulating cover is a drawer movable on the torque support between a rest position and an actuating position, the drawer comprises a bearing zone, the drawer is configured so that a force exerted on the bearing zone tilts the drawer from its rest position to its actuating position, and the drawer is configured to actuate a selection device of the electronic board when it tilts to the actuating position.
The drawer comprises elastically deformable lugs, bearing against the torque support, configured to push the drawer back from its actuated position to its rest position in the absence of force exerted on the bearing zone.
The recess comprises two walls that are substantially parallel to each other, between which the electronic board is at least partially housed, and the drawer slides between the walls of the recess.
The insulating cover comprises a light guide, made of translucent material and guiding light emitted by a source of illumination from the electronic board to the outside of the electromechanical actuator.
The insulating cover is snap-fitted onto the torque support.
The insulating cover comprises two side walls, parallel to each other and perpendicular to an axis of rotation of the electromechanical actuator, an end wall, which connects the two side walls, the space for receiving the electronic board is formed between the two side walls and the end wall, the end wall is in the form of an arc of a circle, and the end wall is flush with an external surface of the torque support.
The torque support comprises a central stud, the electronic board comprises a cut-out, and the electronic board is mounted in the recess while being held clamped to the central stud by its cut-out.
The electronic board also comprises a connector, and the insulating cover comprises a projection surrounding the connector.

According to a second aspect, the present invention relates to a closure, occultation or solar protection installation comprising a screen that can be rolled up on a winding tube and driven to move by an electromechanical actuator, according to the invention and as mentioned above.

This installation has similar features and advantages to those described above in relation to the electromechanical actuator according to the invention.

Further features and advantages of the invention will become apparent from the following description, made with reference to the attached drawings, which are given as non-limiting examples and wherein:

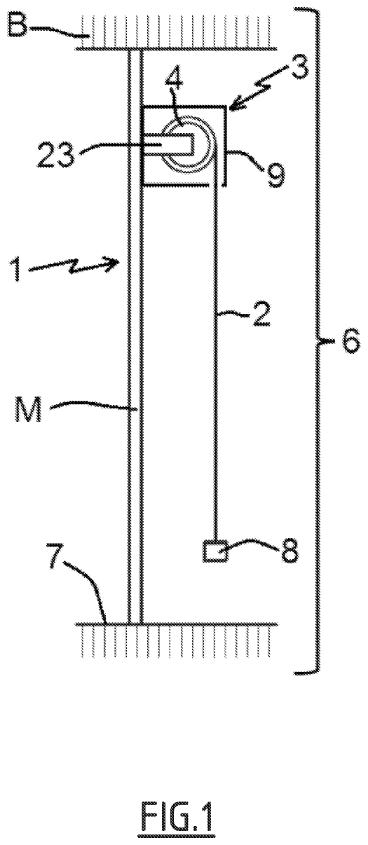

FIG. 1 is a schematic transverse cross-section view of a occultation installation according to the invention;

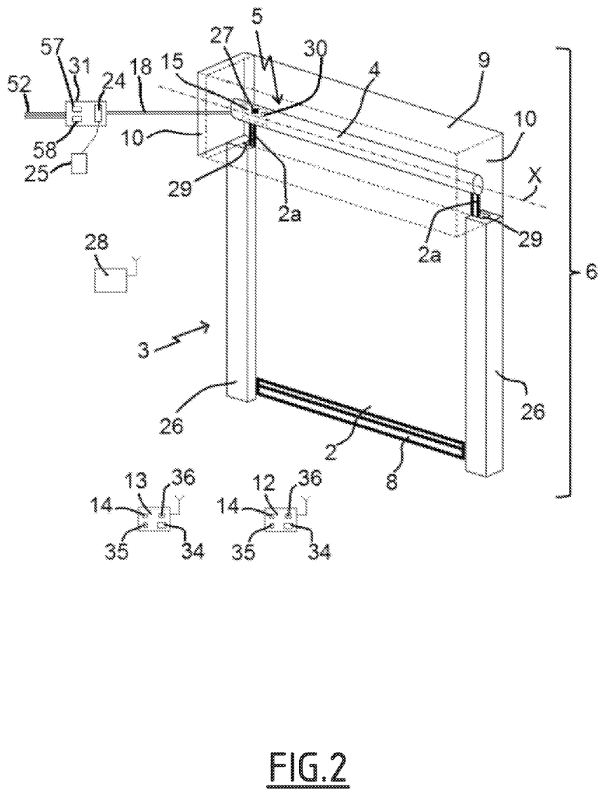

FIG. 2 is a schematic perspective view of the installation illustrated in FIG. 1;

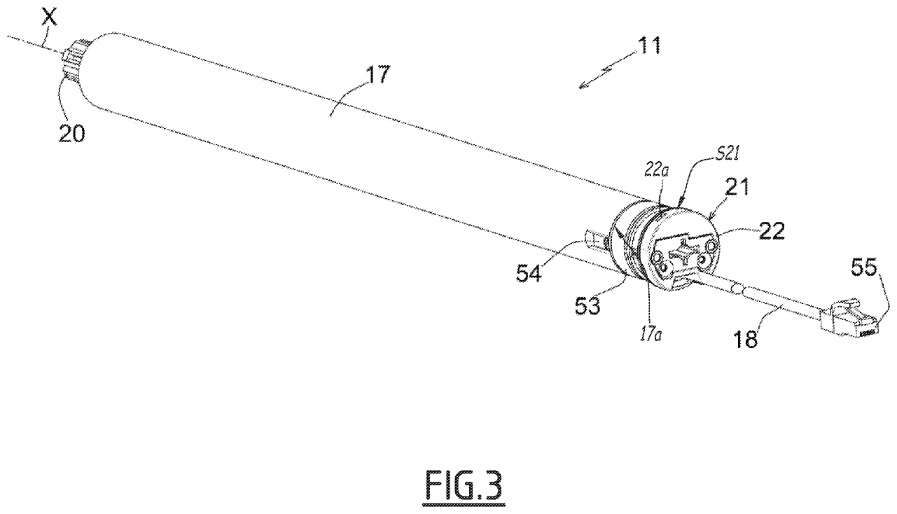

FIG. 3 is a perspective schematic view of an electromechanical actuator according to the invention and belonging to the installation illustrated in FIGS. 1 and 2;

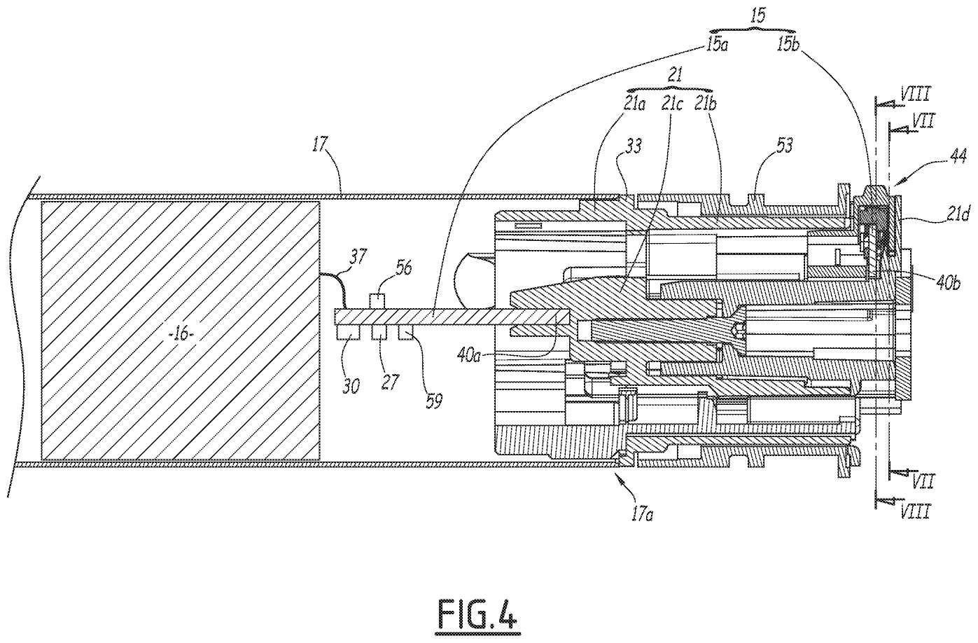

FIG. 4 is a partial longitudinal cross-section of the electromechanical actuator illustrated in FIG. 3;

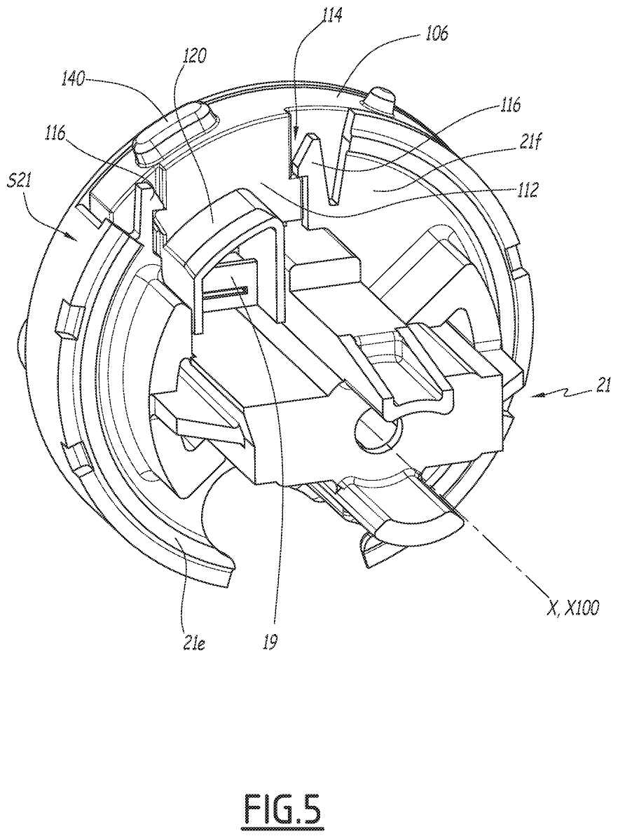

FIG. 5 is a perspective schematic view of a torque support and an insulating cover belonging to the electromechanical actuator of FIGS. 3 to 4;

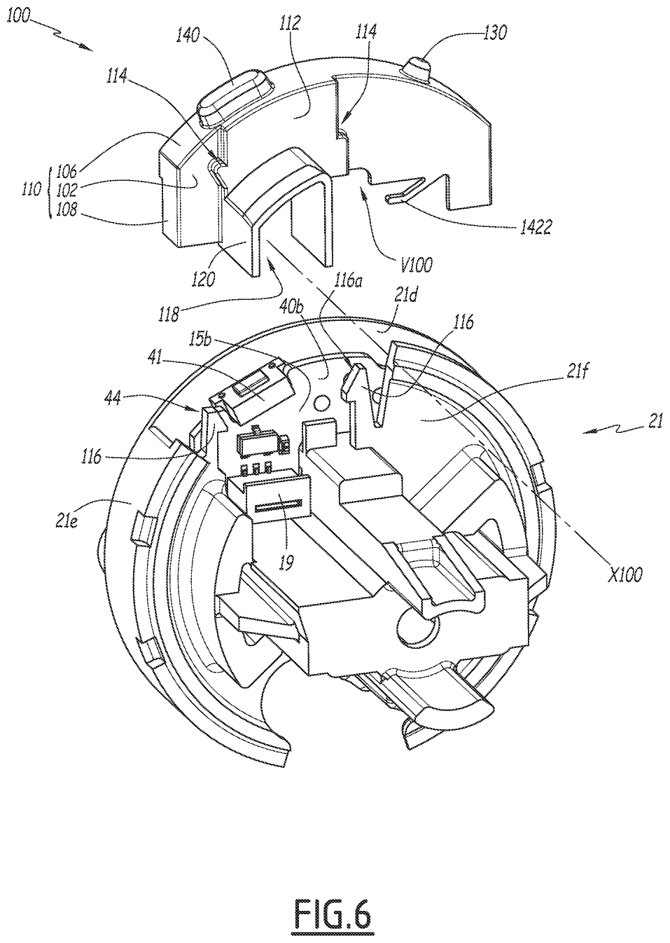

FIG. 6 is an exploded perspective schematic view of the torque support and of the cover of FIG. 5;

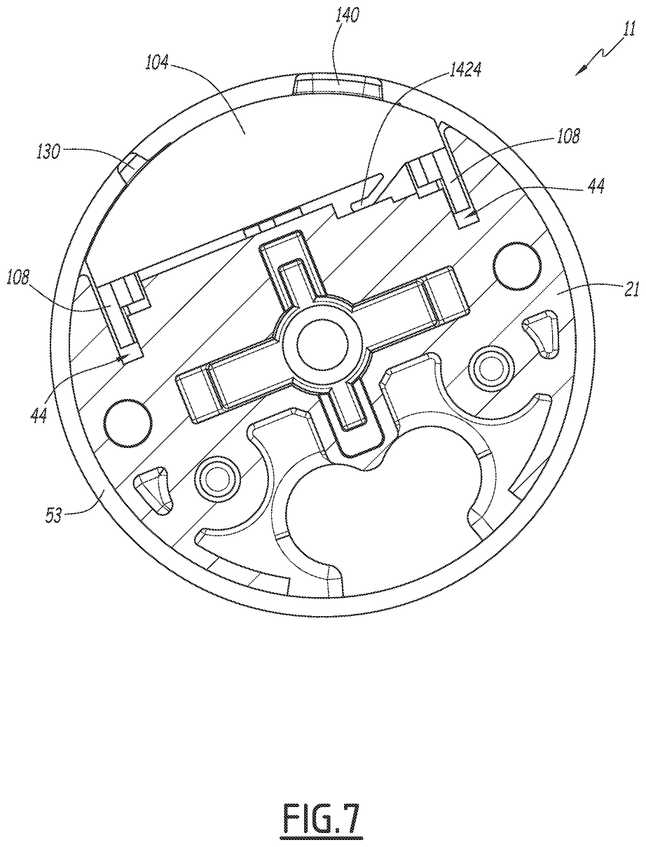

FIG. 7 is a cross-section along plane VII of FIG. 4, in which only the torque support and drawer cover of FIGS. 5 and 6 are shown;

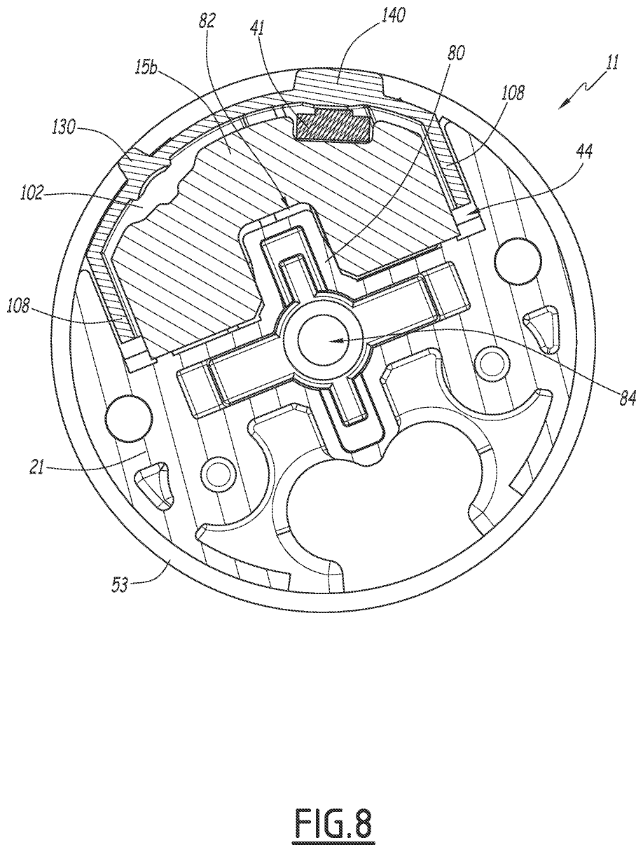

FIG. 8 is a cross-section along plane VIII of FIG. 4, in which only the torque support and the cover of FIGS. 5 and 6 are shown;

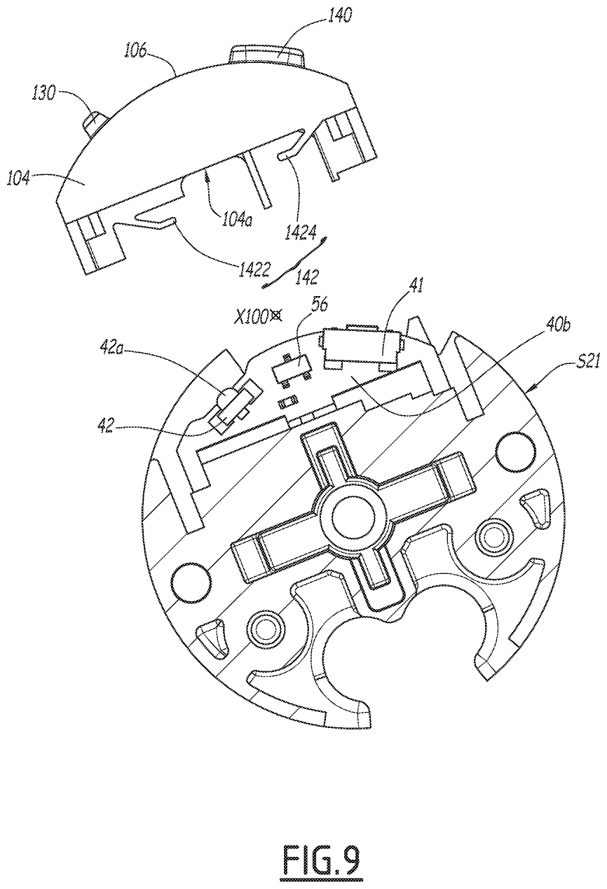

FIG. 9 is a cross-section similar to FIG. 7 in the exploded configuration of FIG. 6; and

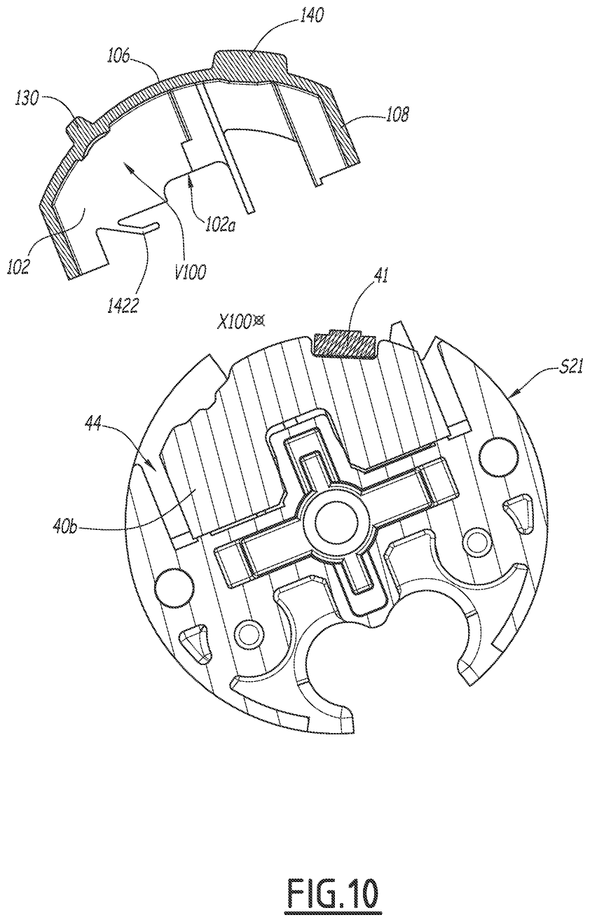

FIG. 10 is a cross-section similar to FIG. 8 in the exploded configuration of FIG. 6.

Firstly, with reference to FIGS. 1 and 2, an installation 6 comprising a closure, occultation or solar protection device 3, this installation being according to a first embodiment of the invention, installed in a building B comprising an opening 1, which is a window or door, is described. This installation 6 is equipped with a screen 2 belonging to the closure, occultation or solar protection device 3, in particular a motorised blind.

The closure, occultation or solar protection device 3 is hereinafter referred to as the “occultation device”. The occultation device 3 comprises the screen 2.

The occultation device 3 may comprise a blind, such as a rollable canvas, pleated blind or slatted blind. The present invention is applicable to all types of occultation devices.

With reference to FIGS. 1 and 2, a roller blind which comprises an electromechanical actuator according to the first embodiment of the invention is described.

The occultation device 3 comprises a winding tube 4 and a motorized driving device 5. The motorized driving device 5 comprises an electromechanical actuator 11 illustrated in FIG. 4.

The screen 2 of the occultation device 3 is rolled onto the winding tube 4 driven by the motorized driving device 5. Thus, the screen 2 can be moved between a rolled position, in particular a high position, and an unrolled position, in particular a low position.

The screen 2 of the occultation device 3 is a closure, occultation, and/or solar protection screen which can be wound and unwound around the winding tube 4, the inner diameter of which is greater than the outer diameter of the electromechanical actuator 11, so that the electromechanical actuator 11 can be inserted into the winding tube 4 when the occultation device 3 is assembled.

Advantageously, the occultation device 3 further comprises a retaining device 9, 23.

Advantageously, the retaining device 9, 23 may comprise two supports 23. A support 23 is arranged at each end of the winding tube 4, in particular in an assembled configuration of the occultation device 3.

Thus, the winding tube 4 is held by the supports 23. Only one of the supports 23 is visible in FIG. 1. The supports 23 allow the occultation device 3 to be mechanically connected to the structure of the building B, in particular to the wall M of the building B.

Advantageously, the retaining device 9, 23 may comprise a box 9. In addition, the winding tube 4 and at least part of the screen 2 are housed inside the box 9, in particular in the assembled configuration of the occultation device 3.

Generally, the box 9 is arranged above the opening 1, or at the upper part of the opening 1.

Here, as illustrated in FIG. 1, the supports 23 are also housed inside the box 9.

Advantageously, the box 9 comprises two flanges 10, as illustrated in FIG. 2. One flange 10 is arranged at each end of the box 9, particularly in the assembled configuration of the occultation device 3.

In a variant, as illustrated in FIG. 2, the winding tube 4 is held via the box 9, in particular via the flanges 10 of the box 9, without using supports, such as the supports 23 mentioned above.

Advantageously, the occultation device 3 may also comprise two lateral slides 26, as shown only in FIG. 2. Each lateral slide 26 comprises a groove 29. Each groove 29 of one of the lateral slides 26 collaborates, i.e. is configured to collaborate, with a lateral edge 2a of the screen 2, particularly in the assembled configuration of the occultation device 3, so as to guide the screen 2, during the rolling and unrolling of the screen 2 around the winding tube 4.

The electromechanical actuator 11 is for example of the tubular type. This allows the winding tube 4 to be rotated about an axis of rotation X, so that the screen 2 of the occultation device 3 can be unrolled or rolled.

Thus, the screen 2 can be rolled and unrolled on the winding tube 4. In the installed state, the electromechanical actuator 11 is inserted into the winding tube 4.

The occultation device 3 further comprises a load bar 8 for exerting tension on the screen 2.

The roller blind, which forms the occultation device 3, comprises a canvas, which forms the screen 2 of the roller blind 3. A first end of the screen 2, particularly the upper end of the screen 2, in the assembled configuration of the occultation device 3, is fixed to the winding tube 4. Furthermore, a second end of the screen 2, particularly the lower end of the screen 2, in the assembled configuration of the occultation device 3, is fixed to the load bar 8.

Here, the canvas forming the screen 2 is made of a textile material.

In an embodiment not shown, the first end of the screen 2 has a hem through which a rod, in particular one made of plastic, is arranged. This hem at the first end of the screen 2 is achieved by sewing the canvas forming the screen 2. When assembling the screen 2 to the winding tube 4, the hem and the rod at the first end of the screen 2 are slid into a groove on the outside of the winding tube 4, in particular over the entire length of the winding tube 4, so that the screen 2 is rigidly connected to the winding tube 4 and can be wound up, when assembling the screen 2 to the winding tube 4.

In any case, the first end of the screen 2 is arranged at the retaining device 9, 23, such that this first end remains above the opening 1 in the assembled configuration of the occultation device 3.

In the case of a roller blind, the upper rolled position corresponds to a predetermined upper end-of-travel position, or to the bearing of the load bar 8 of the screen 2 against an edge of a box 9 of the roller blind 3, and the lower unrolled position corresponds to a predetermined lower end-of-travel position, or to the bearing of the load bar 8 of the screen 2 against a threshold 7 of the opening 1, or to the complete unrolling of the screen 2.

Advantageously, the motorized driving device 5 is commanded by a command unit. The command unit can be, for example, a local command unit 12 or a central command unit 13.

Advantageously, the local command unit 12 can be connected to the central command unit 13 via a wired or wireless connection.

Advantageously, the central command unit 13 can control the local command unit 12 and other similar local command units distributed throughout the building.

The motorized driving device 5 is preferably configured to execute the commands for closing or opening the screen 2 of the occultation device 3, which can be issued, in particular, by the local command unit 12 and/or the central command unit 13.

The installation 6 comprises the local command unit 12, the central command unit 13, or both the local command unit 12 and the central command unit 13.

The electromechanical actuator 11 belonging to the installation 6 of FIGS. 1 and 2 is now described in more detail with reference to FIGS. 3 and 4.

The electromechanical actuator 11 comprises an electric motor 16. The electric motor 16 is shown by its outline in FIG. 4, without details of its internal components, which are known per se.

Here, the electric motor 16 comprises a rotor and a stator, not shown and positioned coaxially around the axis of rotation X of the winding tube 4 in the mounted configuration of the motorized driving device 5.

Means for commanding the electromechanical actuator 11, allowing the movement of the screen 2 of the occultation device 3, comprise at least one electronic control unit 15. This electronic control unit 15 is able to turn on the electric motor 16 of the electromechanical actuator 11 and, in particular, to enable the supply of electrical energy to the electric motor 16.

Thus, the electronic control unit 15 commands, in particular, the electric motor 16, so as to open or close the screen 2, described previously.

The means of commanding the electromechanical actuator 11 comprise hardware and/or software means.

As a non-limiting example, the hardware means may comprise at least one microcontroller 30.

Advantageously, the electronic control unit 15 further comprises a first communication module 27, in particular for receiving command orders, the command orders being issued by a command emitter, such as the local command unit 12 or central command unit 13, these orders being intended to control the motorized driving device 5.

Advantageously, the first communication module 27 of the electronic control unit 15 is wireless. In particular, the first communication module 27 is configured to receive radio command orders.

Advantageously, the first communication module 27 may also allow the reception of command orders transmitted by wired means.

Advantageously, the electronic control unit 15, the local command unit 12 and/or the central command unit 13 can be in communication with a weather station located inside the building B or remote outside the building B, including, in particular, one or more sensors that can be configured to determine, for example, temperature, brightness, or wind speed, in the case where the weather station is placed outside the building B.

Advantageously, the electronic control unit 15, the local command unit 12, and/or the central command unit 13 can also be in communication with a server 28, as illustrated in FIG. 2, so as to control the electromechanical actuator 11 according to data made available remotely via a communication network, in particular an Internet network that can be connected to the server 28.

The electronic control unit 15 can be controlled from the local command unit 12 and/or central command unit 13. The local command unit 12 and/or central command unit 13 is provided with a control keyboard. The control keyboard of the local 12 or central 13 command unit comprises one or more selection elements 14 and, optionally, one or more display elements 34.

By way of non-limiting examples, the selection elements may include push buttons and/or touch-sensitive keys. The display elements may comprise light emitting diodes and/or an LCD display (Liquid Crystal Display) or TFT (Thin Film Transistor) display. The selection and display elements can also be realised by means of a touch screen.

The local 12 and/or central 13 command unit comprises at least a second communication module 36.

Thus, the second communication module 36 of the local command unit 12 or central command unit 13 is configured to emit, i.e. emits, command orders, in particular by wireless means, e.g. radio, or by wired means.

Furthermore, the second communication module 36 of the local command unit 12 or central command unit 13 may also be configured to receive, i.e. receives, command orders, in particular via the same means.

The second communication module 36 of the local command unit 12 or central command unit 13 is configured to communicate, i.e. communicates, with the first communication module 27 of the electronic control unit 15.

Thus, the second communication module 36 of the local command unit 12 or central command unit 13 exchanges command orders with the first communication module 27 of the electronic control unit 15, either monodirectionally or bidirectionally.

Advantageously, the local command unit 12 is a command point, which may be fixed or mobile. A fixed command point can be a control box to be fixed on a façade of a wall M of the building B or on a face of a window or door frame. A mobile command point can be a remote control, a smartphone or a tablet.

Advantageously, the local 12 and/or central 13 command unit further comprises a controller 35.

The motorized driving device 5, in particular the electronic control unit 15, is preferably configured to carry out command orders for controlling the movement, in particular the closing and opening, of the screen 2 of the occultation device 3. These command orders can be emitted, for example, by the local command unit 12 or by the central command unit 13.

The motorized driving device 5 can be controlled by the user, for example by receiving a command order corresponding to pressing the or one of the selection elements 14 of the local command unit 12 or central command unit 13.

The motorized driving device 5 can also be controlled automatically, for example by receiving a command order corresponding to at least one signal from at least one sensor, not shown, and/or a signal from a clock, not shown, of the electronic control unit 15, in particular the microcontroller 30. The sensor and/or the clock may be integrated in the local command unit 12 or in the central command unit 13.

The electromechanical actuator 11 comprises a housing 17, in particular a tubular one. The electric motor 16 is mounted inside the housing 17, in particular in an assembled configuration of the electromechanical actuator 11.

Here, the housing 17 of the electromechanical actuator 11 is cylindrical in shape, in particular rotationally symmetrical about the axis of rotation X.

In one embodiment, the housing 17 is made of a metallic material.

The material of the electromechanical actuator housing is not limiting and can be different. In particular, it may be a plastic material.

Advantageously, the occultation device 3 further comprises an electrical energy supply device 31.

Here, the electromechanical actuator 11 is configured to be electrically connected, i.e. is electrically connected, to the electrical energy supply device 31.

The electromechanical actuator 11 further comprises electrical conductors 37, for example in cable or ribbon form.

Here, the electrical conductors 37 extend between the electronic control unit 15 and the electric motor 16, as illustrated in FIG. 4.

The electromechanical actuator 11 further comprises an electric supply cable 18.

The electrical conductors 37 are configured to be connected to an electrical energy supply network 52, by means of the supply cable 18.

The electric motor 16 is supplied with electrical power via the electrical conductors 37, which are in turn electrically connected to the supply cable 18.

Thus, the electric motor 16 is configured to be supplied, i.e. is supplied, with electrical energy from the electrical energy supply network 52, through the supply cable 18.

Advantageously, the supply cable 18 is connected to the electrical energy supply network 52 by means of an electrical connector 55, visible in FIG. 3.

In this way, the electrical conductors 37 of the electromechanical actuator 11 are configured to be electrically connected, i.e. are electrically connected, to the supply cable 18.

Here, the electromechanical actuator 11 further comprises the electronic control unit 15.

Advantageously, the electronic control unit 15 comprises a first electronic board 15a and a second electronic board 15b.

Advantageously, the electronic control unit 15 and, more particularly, each of the first and second electronic boards 15a, 15b comprises at least one printed circuit board 40a, 40b.

Advantageously, the or each printed circuit board 40a, 40b is equipped with electronic components 56.

The electrical conductors 37 are made by means of electrical wires and/or electrical tracks of the or each printed circuit board 40a, 40b of the electronic control unit 15. Only the part of the electrical conductors 37 made of electrical wires is visible in FIG. 4.

Advantageously, the electronic components 56 comprise the first communication module 27 and the microcontroller 30.

The supply cable 18 comprises an electrical connector 59, which is configured to electrically connect, i.e. electrically link, the supply cable 18 to the electronic control unit 15, in particular to the first and second electronic boards 15a, 15b and, more particularly, to the printed circuit board 40a, 40b of each of these first and second electronic boards 15a, 15b.

Here, the supply cable 18, is electrically connected, i.e. is configured to be electrically connected, to electrical tracks, not shown, of the first printed circuit board 40a by means of the electrical connector 59 of the supply cable 18.

Here, the voltage of the electrical energy supply network 52 is, preferably, continuous and called “very low voltage”. The value of the voltage of the electrical energy supply network 52 is, preferably, less than or equal to 120 volts and, more particularly, less than or equal to 50 volts. The value of the voltage of the electrical energy supply network 52 may be, for example, on the order of 12 volts, 24 volts or 48 volts.

As a non-limiting example, the electrical energy supply network 52 may be a “PoE” (Power over Ethernet) network.

Here, the electric motor 16 may be of the electronically commutated brushless type, also known as “BLDC” (BrushLess Direct Current) or “permanent magnet synchronous”, or DC type.

Advantageously, the electrical energy supply device 31 may comprise at least one battery 24.

The battery 24 can be arranged in the box 9 of the occultation device 3. The battery 24 can thus be arranged inside or outside the box 9. The battery 24 may also be arranged inside the winding tube 4, but outside the housing 17. The electromechanical actuator 11 may also comprise the battery 24. The battery 24 may thereby be arranged inside the housing 17, in particular in an assembled configuration of the electromechanical actuator 11.

Advantageously, the electrical energy supply device 31 may further comprise at least one hub 57 and, optionally, at least one adapter 58, in particular in the case where the electromechanical actuator 11 is configured to be electrically connected, i.e. is electrically connected, to a so-called “PoE” power supply network.

Advantageously, the electrical power supply cable 18 is configured to supply electrical power, i.e. supplies electrical power, to the electromagnetic actuator 11, in particular to the electronic control unit 15 and the electric motor 16, in particular from the electrical power supply device 31, in particular from the battery 24.

Advantageously, the battery 24 comprises one or more energy storage cells. The energy storage cells of the battery 24 may be, for example, rechargeable batteries, in which case the battery 24 is of the rechargeable type, or cells.

Advantageously, the motorized driving device 5 and, in particular, the electronic control unit 15, comprises charging elements configured to charge the battery 24 from the electrical energy supplied by an external electrical energy supply source 25, as illustrated in FIG. 2.

Advantageously, the external electrical energy supply source 25 is a charger that can be connected, i.e. is connected, to a wall socket, so as to recharge the battery 24 from a mains electrical energy supply.

Advantageously, the first electronic board 15a is configured to control the electric motor 16. In addition, the second electronic board 15b is configured to access functions for setting parameters and/or configuring the electromechanical actuator 11, by means of selection devices 41 and, possibly, display devices 42, not shown. In addition, the second electronic board 15b may be configured to allow recharging of the battery 24.

Here, and by no means restrictively, the loading elements are arranged on the second electronic board 15b.

The electromechanical actuator 11 further comprises an output shaft 20.

Advantageously, the electromechanical actuator 11 further comprises a gearbox, not shown, which comprises at least one reduction stage. The reduction stage can be an epicyclic gear train. The gearbox is configured to be arranged, i.e. is arranged, between the electric motor 16 and the output shaft 20.

The type and number of reduction stages of each of the gearbox are not limiting.

Advantageously, the electromechanical actuator 11 further comprises a brake, not shown.

By way of non-limiting example, the brake can be a spring brake, a cam brake, a magnetic brake, or an electromagnetic brake.

The brake is configured to brake and/or rotationally lock the output shaft 20 so as to regulate the rotational speed of the winding tube 4 when the screen 2 is moved, and to keep the winding tube 4 locked, when the electromechanical actuator 11 is electrically deactivated.

The brake is configured to be arranged, i.e. is arranged, between two reduction stages of the gearbox, or between the electronic control unit 15 and the electric motor 16, i.e. at the input of the electric motor 16, or between the gearbox and the output shaft 20, i.e. at the output of the gearbox, or between the electric motor 16 and the gearbox, i.e. at the output of the electric motor 16.

Advantageously, the gearbox, and potentially, the brake are arranged inside the housing 17 of the electromechanical actuator 11, in the assembled configuration of the electromechanical actuator 11.

The winding tube 4 is rotated about the axis of rotation X and the housing 17 of the electromechanical actuator 11 and is supported by two pivot connections.

The first pivot connection is made at a first end of the winding tube 4 by means of an annulus 53. The annulus 53 thus makes it possible to create a bearing.

The second pivot connection, not shown, is made at a second end of the winding tube 4.

The electromechanical actuator 11 further comprises a torque support 21, which may also be called the “actuator head”.

Here, the torque support 21 is arranged on the first end 17a of the housing 17 of the electromechanical actuator 11, particularly in the assembled configuration of the electromechanical actuator 11.

The torque support 21 makes it possible to react to the load applied by the electromechanical actuator 11 and, in particular, to ensure that the load applied by the electromechanical actuator 11, in particular the torque applied by the electromechanical actuator 11, is taken up by the building structure B. Advantageously, the torque support 21 also allows the load applied by the winding tube 4, in particular the weight of the winding tube 4, the electromechanical actuator 11 and the screen 2, to be taken up and to ensure that this load is taken up by the building structure B.

The torque support 21 of the electromechanical actuator 11 thus allows the electromechanical actuator 11 to be fixed to a retaining device 9, 23, in particular to one of the supports 23 or to one of the flanges 10 of the box 9.

Advantageously, the torque support 21 protrudes from the first end 17a of the housing 17 of the electromechanical actuator 11, in particular the end 17a of the housing 17 receiving the ring 53. The ring 53 constitutes, or is configured to constitute, a bearing for the rotational guidance of the winding tube 4, particularly in the assembled configuration of the occultation device 3.

Advantageously, the torque support 21 of the electromechanical actuator 11 may allow the first end 17a of the housing 17 to be shuttered.

In addition, the torque support 21 of the electromechanical actuator 11 can support at least part of the electronic control unit 15.

Advantageously, the torque support 21 is fixed to the housing 17 by means of one or more fastening elements 54, in particular in the assembled configuration of the electromechanical actuator 11. The fastening element(s) 54 may be, for example, bosses, as illustrated in FIG. 3, fastening screws, elastic snap-in fastening elements, grooves in indentations, or a combination thereof.

Advantageously, the torque support 21 comprises a first part 21a and a second part 21b.

Advantageously, the first part 21a of the torque support 21 is configured to collaborate, i.e. collaborates, with the housing 17 of the electromechanical actuator 11, in particular in the assembled configuration of the electromechanical actuator 11. Furthermore, the second part 21b of the torque support 21 is configured to collaborate, i.e. collaborates, with the retaining device 9, 23, in particular in an assembled configuration of the electromechanical actuator 11 in the occultation device 3.

Advantageously, the construction of the torque support 21 comprising the first and second parts 21a, 21b made of a single piece improves the rigidity of the torque support 21.

Advantageously, at least a portion of the first part 21a of the torque support 21 is generally cylindrical in shape and is arranged within the housing 17 of the electromechanical actuator 11, particularly in the assembled configuration of the electromechanical actuator 11.

Advantageously, an outer diameter of at least a portion of the second part 21b of the torque support 21 is larger than an outer diameter of the housing 17 of the electromechanical actuator 11.

Advantageously, the torque support 21 further comprises a limit stop 33. Furthermore, the stop 33 is in abutment, i.e. is configured to be in abutment, with the housing 17, at the first end 17a of the housing 17, particularly in the assembled configuration of the electromechanical actuator 11.

Thus, the limit stop 33 of the torque support 21 makes it possible to limit the placement of the first part 21a of the torque support 21 into the housing 17, along the direction of the axis of rotation X.

Furthermore, the limit stop 33 of the torque support 21 delimits the first and second parts 21a, 21b of the torque support 21 from each other.

Thus, only the first portion 21a of the torque support 21 is arranged inside the housing 17 of the electromechanical actuator 11, following the fitting of the torque support 21 inside the housing 17, up to the limit stop 33, particularly in the assembled configuration of the electromechanical actuator 11, and the second portion 21b of the torque support 21 extends outside the housing 17.

Here, the limit stop 33 of the torque support 21 comprises a shoulder and, more particularly, it is made in the form of a flange, in particular of cylindrical shape and with a straight generatrix.

Here and as illustrated in FIGS. 3 and 4, the ring 53 is inserted around the torque support 21, particularly the second part 21b of the torque support 21, particularly in the assembled configuration of the electromechanical actuator 11.

In a variant not shown, the ring 53 is inserted around a first end 17a of the housing 17 of the electromechanical actuator 11, particularly in the assembled configuration of the electromechanical actuator 11.

Advantageously, the output shaft 20 of the electromechanical actuator 11 is arranged inside the winding tube 4 and at least partly outside the housing 17 of the electromechanical actuator 11.

Here, one end of the output shaft 20 protrudes from the housing 17 of the electromechanical actuator 11, in particular from a second end 17b of the housing 17 opposite the first end 17a.

Advantageously, the output shaft 20 of the electromechanical actuator 11 is configured to rotate a connecting element, not shown, connected to the winding tube 4. The connecting element is in the form of a wheel.

When the electromechanical actuator 11 is switched on, the electric motor 16 and the gearbox rotate the output shaft 20. In addition, the output shaft 20 of the electromechanical actuator 11 rotates the winding tube 4 via the connecting element.

Thus, the winding tube 4 rotates the screen 2 of the occultation device 3, so that the opening 1 is opened or closed.

The electronic control unit 15 of the electromechanical actuator 11 comprises a device to detect obstacles and end-of-travel, not shown, during the winding of the screen 2 and during the unwinding of that screen 2.

The device to detect obstacles and end-of-travel during the winding and unwinding of the screen 2 is implemented by means of the microcontroller 30 of the electronic control unit 15 and, in particular, by means of an algorithm implemented by this microcontroller 30.

Here, the electronic control unit 15, in particular the first and second electronic boards 15a, 15, are supplied with electrical energy by means of the supply cable 18.

Advantageously, the electronic control unit 15 is arranged at least partly inside the housing 17 of the electromechanical actuator 11.

Furthermore, the electronic control unit 15 may be at least partly arranged outside the housing 17 of the electromechanical actuator 11 and, in particular, mounted in the torque support 21.

Here, the first electronic board 15a of the electronic control unit 15 is arranged inside the housing 17 of the electromechanical actuator 11, particularly in the assembled configuration of the electromechanical actuator 11. Furthermore, the second electronic board 15b is arranged within the torque support 21 of the electromechanical actuator 11, particularly in the assembled configuration of the electromechanical actuator 11.

Here, the electronic control unit 15 does not have a case for receiving the first electronic board 15a. This first electronic board 15a is, on the one hand, held, in particular plugged, in the torque support 21, in particular in a third central part 21c of the torque support 21, as illustrated in FIG. 4, and on the other hand, held, in particular plugged into a support, not shown, mounted at the end of the electric motor 16, particularly in the assembled configuration of the electromechanical actuator 11.

Here, and more visibly in FIGS. 8 and 10, the second electronic board 15b is held, in particular plugged, in a central stud of the torque support 21, particularly in a central stud of the second part 21b of the torque support 21.

In particular, the second electronic board 15b is arranged inside a recess 44 formed in the second part 21b of the torque support 21, more precisely in a head 21e of the second part 21b. The recess 44 is delimited, along the axis X, on the one hand by a wall 21d of the torque support 21, visible in FIGS. 4 and 6 and which forms, along the axis X, one end of the head 21e of the second part 21b of the torque support 21, and on the other hand by a wall 21f of the torque support 21, visible in FIGS. 5 and 6, substantially parallel to the wall 21d and arranged, along the axis X, between the wall 21d and the housing 17. Furthermore, the outer surface of the head 21e of the second part 21b is cylindrical in shape.

In practice, the second electronic board 15b has a U-shaped cut-out 82. The second electronic board is mounted and held tightly in the recess 44. The cut-out 82 surrounds the central stud 80 of the torque support 21, so that the central stud rests against the cut-out 82 and the second electronic board rests against the bottom of the recess 44. The second electronic board 15b is then pressed into the recess 44 and held tightly against the central stud 80 by its cut-out. The cut-out 82 is therefore substantially complementary in shape to the central stud 80.

This fastening method is advantageous because it allows the second electronic board to be mounted and dismounted reliably, without tools and without the use of fasteners such as screws. However, any other solution for holding the second electronic board 15b in the recess 44 is conceivable.

In addition, the central stud 80 is hollow and cooperates with an opening 84, which in the example is in the shape of a four-pointed cross, and which is configured to cooperate with one of the supports 23 to hold the electromechanical device 11 mounted in the installation 6. The configuration of the hollow central stud and the opening can be seen in

FIG. 8. One of the branches of the opening 84 is thus formed in the central stud 80. The cut-out 82 of the second electronic board 15b is therefore advantageous, as it optimises the placement of the electronic components of the second electronic board on either side of the central stud 80, which optimises the space available in the torque support 21, while keeping the opening 84 available for a multiplicity of different supports 23.

Advantageously, the first and second electronic boards 15a and 15b are connected to each other by connecting cables, not shown.

In addition, the electronic board 15b comprises a connector 19, which is mounted on the printed circuit board 40b and allows the connection of the connecting cables between the first and second electronic boards. In practice, the connector 19 extends perpendicular to the printed circuit board 40b.

Here and as illustrated in FIG. 3, the torque support 21 further comprises a cap 22. The cap 22 is mounted on the end of the second part 21b of the torque support 21, more precisely on the head 21e of the second part 21b, in particular in the assembled configuration of the electromechanical actuator 11. In FIG. 4, the cap 22 is omitted for clarity.

The torque support 21 comprises at least one selection device 41, in particular a button, which may be, for example, a push button.

Said selection device(s) 41 are configured to, when activated, carry out an adjustment of the electromechanical actuator 11 through one or more configuration modes, to pair with the electromechanical actuator 11 one or more command units 12, 13, to reset one or more parameters, which may be, for example, an end position, to reset the paired command unit or units 12, 13 or to control the movement of the screen 2.

Here, the torque support 21 comprises a single selection device 41.

The number of selection devices of the torque support is not limiting and may be different. It may in particular be greater than or equal to two.

The torque support 21 comprises at least one display device 42.

This display device or these display devices 42 are configured to display a visual indication, which may be, for example, representative of an operating mode of the electromagnetic actuator 11, in particular a configuration mode or a control mode, or of a status of a member of the motorized driving device 5 or of the electrical energy supply device 31, in particular a charging status of the battery 24.

Advantageously, the display device 42 comprises at least one illumination source 42a, in particular a light-emitting diode, mounted on a second electronic board 15b.

Here, the torque support 21 comprises a single display device 42.

The number of display devices is not limiting and may be different. It may in particular be greater than or equal to two.

Advantageously, the selection device 41 and the display device 42 are electrically connected, i.e. are configured to be electrically connected, to the electronic control unit 15.

Here, the selection device 41 and the display device 42 are electrically connected, i.e. are configured to be electrically connected, to the second electronic control board 15b.

Advantageously, the selection device 41 and the display device 42 are mounted on the printed circuit board 40b.

In a variant, the selection device 41 and/or the display device 42 may be electrically connected, i.e. may be configured to be electrically connected, to the first electronic control board 15a.

The torque support 21 may comprise either the selection device(s) 41 or the display device(s) 42, or the selection device(s) 41 and the display device(s) 42.

The recess 44 accommodates, i.e. is configured to accommodate, at least the selection device(s) 41 or display device(s) 42, in particular in the assembled configuration of the electromechanical actuator 11.

In this way, the recess 44 receives, i.e. is configured to receive, at least one of the selection device(s) 41 or display device(s) 42, in particular in the assembled configuration of the electromechanical actuator 11.

Here, the torque support 21 comprises a single recess 44, where the selection device 41 and the display device 42 are housed.

Alternatively, not shown, the torque support 21 may comprise a first recess 44 for the selection device 41 and a second recess 44 for the display device 42. The torque support 21 may further comprise a first recess 44 for each selection device 41 or for a plurality of selection devices 41, in the event that the torque support 21 has a plurality of selection devices 41, and a second recess 44 for each display device 42 or for a plurality of display devices 42, in the event that the torque support 21 has a plurality of display devices 42.

The electromechanical actuator 11 also comprises an electrically insulating cover 100, which is now described in more detail with reference to FIGS. 4 to 10.

In this example, the insulating cover 100 forms a drawer.

This drawer 100 is configured to protect the second electronic board 15b, and more particularly the printed circuit board 40b and the electronic components 56 mounted thereon, such as for example the selection device 41 and the display device 42, against electrostatic discharges, in other words protects them against electrostatic discharges.

Advantageously, the drawer 100 also protects the second electronic board 15b from splashing water and humidity.

The material of the drawer 100 is chosen to be electrically insulating and preferably watertight.

The material of the drawer 100, for example, meets the requirements of Performance Level 3 (PLC 3) as defined by the Comparative Tracking Index (CTI) of the IEC 60112 standard.

Advantageously, the drawer 100 is made of a polymer material, for example acrylonitrile butadiene styrene, also known as ABS. Preferably, this material is at least partially translucent.

In practice, as can be seen in FIGS. 6 to 10, the drawer 100 comprises two side walls 102 and 104, parallel to each other and perpendicular to the axis of rotation X when the drawer 100 is mounted on the electromechanical actuator 11. The side walls 102 and 104 are connected by an end wall 106. In practice, the wall 104 slides parallel opposite the wall 21d of the torque support 21 and the wall 102 slides parallel to the wall 21f of the torque support 21.

Advantageously, the end wall 106 is in the form of an arc of a circle centred on an axis X100 parallel to the axis of rotation X in the assembled configuration of the actuator 11, the radius of curvature of which is identical to the radius of curvature of the outer surface S21 of the head 21e of the torque support 21.

Advantageously, the drawer 100 also comprises two sides 108, parallel to each other and perpendicular to the side walls 102 and 104, which connect the side walls to each other at the ends of the end wall 106. The sides 108 extend the wall 106, between the side walls 102 and 104, on either side of the wall 106.

The side walls 102 and 104, the end wall 106 and the sides 108 form a main body 110 of the drawer 100 and define between them an internal space of the drawer 100, denoted V100.

The shape of the main body 110 is complementary to the shape of the recess 44 of the torque support 21, so that the main body is adapted to be positioned in the recess 44 of the torque support 21. When positioned in the recess 44, the main body 110 of the drawer 100 closes that recess.

In addition, when the drawer 100 is arranged in the recess 44 of the torque support, the main body 110 surrounds the second electronic board 15b, which is arranged in the space V100 of the drawer. The internal space V100 is therefore a space for receiving the second electronic board 15b.

As can be seen in FIG. 8, when the drawer 100 is placed in the recess 44 of the torque support 21, the side walls 102 and 104 and the sides 108 of the main body 110 engage in the recess 44 on either side of the second electronic board 15b, so as to surround at least part of the second electronic board.

The drawer 100 and the recess 44 therefore cooperate to form a protective case for the second electronic board 15b.

In the assembled configuration of the electromechanical actuator 11, the drawer 100 is covered by the cap 22, so that it cannot be accessed by a user.

Advantageously, the side wall 102 of the drawer 100 comprises a boss 112, which extends from the side wall 104 outside the space V100. The boss 112 comprises two shoulders 114.

In addition, the torque support 21 comprises two hooks 116 which extend parallel to the wall 21d.

The hooks 116 and shoulders 114 are configured to cooperate with each other when the drawer 100 is mounted on the torque support 21, so as to keep the drawer mounted in the recess 44. In this way, the drawer 100 is held in the recess 44 and cannot be removed as long as the hooks 116 are engaged on the shoulders 114.

In practice, the hooks 116 are elastically deformable and each comprise a bevelled face 116a. Thus, when the drawer 100 is fitted, the hooks 116 are elastically deformed by their faces 116a bearing against the boss 112, until the drawer reaches its mounted position, visible in particular in FIG. 5, in which the hooks 116 are engaged against the shoulders 114 of the boss 112.

In other words, the drawer 100 is snap-fitted to the torque support 21. In addition, the drawer 100 can be easily removed from the torque support by elastically deforming the hooks 116 so that they are no longer engaged with the shoulders 114 of the boss 112.

This snap-fitting of the drawer 100 to the torque support 21 is particularly advantageous, as the drawer 11 can be mounted and dismounted without tools, as can the second electronic board 15b. This makes it easy to replace the second electronic board in the event of a fault.

Advantageously, the side wall 102 of the drawer 100 also comprises an opening 118, formed on an edge of the side wall opposite the end wall 106, and a projection 120, which extends perpendicularly to the side wall 102 away from the space V100 of the drawer, and whose shape corresponds to the shape of the opening 118. In this way, the opening 118 and the projection 120 together form an open cavity opposite the wall 106, which extends from the side wall 104.

In practice, in the assembled configuration of the electromechanical actuator 11, the projection 120 surrounds the connector 19 of the electronic board 15b, thereby protecting the connector 19 from water splashes and electrostatic discharges.

The drawer 100 also comprises a light guide 130, arranged on the end wall 106. The light guide 130 is positioned so that it faces the display device 42 on the second electronic board 15b, and preferably the illumination source 42a. In this way, the light emitted by the illumination source 42a is directed towards the light guide 130. In addition, the light guide 130 is made of translucent material, so that the light from the lighting source 42a passes right through the light guide 130. Advantageously, the light guide extends from the end wall 106 through an opening in the cap 22, not visible in the figures, so as to be visible from outside the electromechanical actuator 11.

In summary, the light guide 130 is configured to guide the light emitted by the illumination source 42a of the display device 42 to the outside of the electromechanical actuator 11. The light guide 130 is therefore particularly advantageous, as it improves the visibility of the illumination source 42a. Thanks to the light guide 130 in the drawer 100, the light emitted by the illumination source 42a is easily visible from outside the electromechanical actuator 11 without the illumination source having to be directly exposed.

The drawer 100 also comprises a bearing zone 140, arranged on the end wall 106. In the example, the bearing zone 140 is a protrusion which extends from the end wall 106, moving away from the space V100 of the drawer.

Advantageously, the bearing zone 140 is formed of the same piece as the main body 110 of the drawer.

Advantageously, the bearing zone 140 extends through an opening 22a made in the cap 22 and visible in FIG. 3.

The bearing zone 140 is positioned so that it faces the selection device 41 on the second electronic board 15b.

In addition, the drawer 100 comprises at least one elastically deformable tab 142, in the example two elastically deformable tabs 1422 and 1424. In the assembled configuration of the electromechanical actuator 11, the elastically deformable lug(s) 142 rest against the torque support 21.

A first elastically deformable tab 1422 extends from an edge 102a of the side wall 102 opposite the end wall 106. A second elastically deformable tab 1424 extends from an edge 104a of the side wall 104 opposite the end wall 106. The elastically deformable lugs 142 are therefore arranged on either side of the space V100, along the central axis X100. Alternatively, the two elastically deformable lugs are located on the same side of the space V100, preferably on the side of the bearing zone 140. If only one deformable bracket is used, this is advantageously located in the extension of the side wall 102 or 104, on the same side as the bearing zone 140.

The drawer 100 is made of a single piece. In other words, parts 102 to 114 and 118 to 142 are formed of the same piece.

The drawer 100 is movable in the recess 44 between a rest position, illustrated in FIGS. 4, 5, 7 and 8, in which the hooks 116 of the torque support 21 engage against the shoulders 114 of the drawer, and an actuated position. In the actuated position, the drawer 100 is pushed deeper into the recess than in the rest position, i.e. the drawer is closer to the axis of rotation X. In addition, in the actuated position, the hooks 116 of the torque support 21 rest against the boss 112 of the drawer, but are remote from the shoulders 114.

The movement of the drawer 100 between its rest and actuated positions is guided by the recess 44. This movement of the drawer 100 in the recess 44 is a tilting movement.

When the drawer 100 is in the actuated position, the elastically deformable lugs 142 are deformed and exert a force on the torque support 21 which tends to return the drawer 100 to the rest position, i.e. to move, or push back, the drawer until the hooks 116 are engaged against the shoulders 114. The elastically deformable lugs 142 therefore act as elastic means of returning the drawer to its rest position. Thus, when no other force is exerted on the drawer 100, the drawer is held stably in its rest position.

In practice, the drawer 100 tilts into the actuated position when a force is exerted on the end wall 106 of the drawer, and more particularly on the bearing zone 140 of the end wall, in the direction of the axis of rotation X.

In addition, the drawer 100 is configured to actuate, i.e. actuates, the selection device 41 when it is tilted into the actuated position.

In this way, the selection device 41 is activated when a user exerts a pushing force on the bearing zone 140 of the drawer 100.

In other words, the drawer 100 acts as a button, as it is configured to actuate the selection device 41 when a force is exerted on its bearing zone 140.

In addition, when the drawer 100 is in the rest position, i.e. when the hooks 116 are engaged against the shoulders 114, the end wall 106 of the drawer is flush with the outer surface S21 of the head 21e of the torque support 21. “Flush” means that the distance between the outer surface of the head 21e and the axis of rotation X, measured perpendicularly to the axis of rotation X, is equal to the distance between the end wall 106 and the axis of rotation X, measured perpendicularly to the axis of rotation X, plus or minus

When the drawer 100 is in the rest position, the axes X and X100 are coincident.

It is advantageous for the entire drawer 100 to move under the effect of a force exerted by a user, as this avoids the need to create an opening in the drawer to accommodate a button.

In practice, since the bearing zone 140 is off-centre, i.e. closer to one side 108 than to the other side 108, the tilting of the drawer 100 from its rest position to its actuated position is a combination of a clockwise rotation of the drawer 100 on itself according to the viewing angle of FIGS. 7 and 8, and a translation towards the axis X100. In this way, the movement of the bearing zone 140 is maximised, making it easier to actuate the selection device 41.

In addition, the movement of the light guide 130 is minimised, i.e. less than the movement of the bearing zone 140, so that the light guide 130 does not come close, or only slightly close, to the illumination source 42a, which is more aesthetically pleasing when a user presses on the bearing zone 140 of the drawer 100. In addition, the illumination source 42a can be positioned close to the light guide 130, which optimises the transmission of the light emitted by the illumination source through the light guide, without the light guide being in danger of coming into contact with the illumination source.

Thanks to the drawer 100, the second electronic board 15b is effectively protected from splashing water, as the drawer completely covers the second electronic board, closing the recess 44, so that the second electronic board is not exposed to the outside. This means that when a splash of water reaches the electromechanical actuator 11, there is no direct path for this splash of water to reach the second electronic board 15b.

In other words, because there are no openings close to the second electronic board 15b that could open to the outside, the second electronic board 15b and the printed circuit board 40b are protected from splashing water and moisture infiltration, thus preventing damage to the electronic components of the second electronic board.

In practice, it is understood that the second electronic board 15b is protected against splashing water within the meaning of the ingress protection ratings defined by IEC 60529.

Advantageously, the ingress protection rating provided by the drawer 100 to the second electronic board 15b is equal to or greater than IP31.

To this end, the light guide 140 and the bearing zone 140 are particularly advantageous, as they enable the second electronic board 15b to be connected to the outside, respectively by conducting the light emitted by the display device towards the outside and by transmitting a force exerted on the drawer to the selection device, while protecting the second electronic board from the outside.

Thanks to the drawer 100, the second electronic board 15b is protected from discharges of electrostatic charge that may occur within the electromechanical actuator 11.

Indeed, when electrostatic charges are generated, for example by friction of the screen 2 during its winding or unwinding, and then evacuated to an earth point, for example via the supply cable 18, these charges are propagated inside the electromechanical actuator 11 by being carried by conductive elements of the actuator, such as the housing 17. In addition, the shape of the drawer 100, more particularly the shape of the main body 100 defining an internal space in which the second electronic board 15b is received, increases the length of a path travelled by an electrostatic discharge, between the outside of the drawer 100 and the second electronic board 15b. The length of this path is greater than that required to dissipate a discharge of electrostatic charges that may occur in the electromechanical actuator 11.

More precisely, to reach the second electronic board 15b, an electronic load carried by the housing 17 must at least run along one of the side walls 102 or 104, from the end wall 106, to the edge 102a or 104a of that side wall, before reaching the internal space V100. As this pathway is at a distance from any conductive element, it allows the second electronic board to be immune to electrostatic discharges below voltages on the order of 15 kV to 20 kV.

In addition, the projection 120 also increases the path of an electrostatic discharge between the housing 17 and the connector 19, thereby protecting the connector from electrostatic discharges.

Alternatively, the drawer 100 is fastened in the torque support 21 by means of fastening hooks, which hook onto the torque support. In this variant, the drawer 100 might not have a boss 112.

Alternatively, the drawer 100 can be returned to the rest position using return means other than the two elastically deformable lugs 1422, such as deformable lugs arranged on the sides 108 or an elastic return member, such as a spring.

Alternatively, the insulating cover 100 is not movable in the recess 44. In such a variant, the bearing zone 140 is made of a flexible material, so that it can be deformed when a force is exerted on it, without causing the cover 100 to move, and so that the selection device 41 can be actuated.

Numerous modifications can be made to the above-described embodiments without departing from the scope of the invention.

In a variant, not shown, the electromechanical actuator 11 is inserted in a rail, in particular of square or rectangular cross-section, which can be opened at one or both ends, particularly in the assembled configuration of the occultation device 3. In addition, the electromechanical actuator 11 may be configured to drive a drive shaft on which cords for moving and/or orienting the screen 2 are wound.

Furthermore, the envisaged embodiments and variants may be combined to form new embodiments of the invention, without departing from the scope of the invention.

1. An electromechanical actuator for driving a winding tube of a closure, occultation or solar protection installation, the electromechanical actuator comprising at least:
a housing,
a torque support, the torque support being arranged at a first end of the housing,
an electric supply cable, the electric supply cable being configured to be connected to an electrical energy supply network,
an electric motor, the electric motor being mounted within the housing, the electric motor being supplied with electrical power via the electric supply cable,
an electronic control unit comprising at least one electronic board, the at least one electronic board being arranged inside the torque support,
wherein the torque support forms a recess in which the at least one electronic board is at least partially inserted, and the electromechanical actuator also comprises an electrically insulating cover, forming a space for receiving at least part of the at least one electronic board, the insulating cover closing the recess of the torque support, the recess and the insulating cover together forming a protective case for the at least one electronic board.

2. The electromechanical actuator according to claim 1, wherein the insulating cover is a drawer movable on the torque support between a rest position and an actuating position, wherein the drawer comprises a bearing zone, wherein the drawer is configured so that a force exerted on the bearing zone tilts the drawer from its rest position to its actuating position, and wherein the drawer is configured to actuate a selection device of the at least one electronic board when the drawer tilts to the actuating position.

3. The electromechanical actuator according to claim 2, wherein the drawer comprises elastically deformable lugs, bearing against the torque support, configured to push the drawer back from its actuating position to its rest position in the absence of force exerted on the bearing zone.

4. The electromechanical actuator according to claim 2, wherein the recess comprises two walls substantially parallel to each other, between which the at least one electronic board is recessed at least in part, and wherein the drawer slides between the walls of the recess.

5. The electromechanical actuator according to claim 1, wherein the insulating cover comprises a light guide made of a translucent material and guiding light emitted by an illumination source of the at least one electronic board towards the outside of the electromechanical actuator.

6. The electromechanical actuator according to claim 1, wherein the insulating cover is snap-fitted on the torque support.

7. The electromechanical actuator according to claim 1, wherein the insulating cover comprises:
two side walls, parallel to each other and perpendicular to an axis of rotation of the electromechanical actuator,
an end wall, which connects the two side walls,
wherein the space for receiving the at least one electronic board is formed between the two side walls and the end wall,
wherein the end wall has a shape of an arc of a circle,
and wherein the end wall is flush with an outer surface of the torque support.

8. The electromechanical actuator according to claim 1, wherein the torque support comprises a central stud, wherein the at least one electronic board comprises a cut-out, and wherein the at least one electronic board is mounted in the recess while being held clamped to the central stud by its cut-out.

9. The electromechanical actuator according to claim 1, wherein the at least one electronic board further comprises a connector, and wherein the insulating cover comprises a projection surrounding the connector.

10. A closure, occultation or solar protection installation comprising a winding screen on a winding tube and driven in movement by an electromechanical actuator, wherein the electromechanical actuator is according to claim 1.
